(19) United States
(12) Patent Application Publication
(10) Pub. No.: US 2021/0040837 A1
(43) Pub. Date: Feb. 11, 2021

(54) AUTOMATED SAND GRAIN BRIDGE STABILITY SIMULATOR

(71) Applicant: Saudi Arabian Oil Company, Dhahran (SA)

(72) Inventor: Majed N. Al-Rabeh, Khobar (SA)

(73) Assignee: Saudi Arabian Oil Company, Dhahran (SA)

(21) Appl. No.: 16/535,985

(22) Filed: Aug. 8, 2019

(51) Int. Cl. E21B 47/00; G01L 5/16; E21B 43/08; E21B 43/04

(52) U.S. Cl. CPC E21B 47/00; E21B 43/04; E21B 43/086; G01L 5/16

(57) ABSTRACT

An automated sand grain bridge simulator obtains field data that is associated with a stand-alone sand screen completion and well and sand grain elastic and plastic deformation data. An expected stress profile along a sand grain bridge throughout the life of the wellbore is iteratively determined. The sand grain bridge is formed on screen openings of the stand-alone screen completion. The expected stress profile is compared to a predetermined range of elastic and plastic deformation limits. It is determined whether the stand-alone sand screen completion is sufficient to retain downhole sands which results in improved engineering design, field performance and saves the cost of comprehensive dynamic laboratory testing.

### TECHNICAL FIELD

The present disclosure relates to oil, gas and water field production and, in particular, to simulating stand-alone sand screen performance in laboratory and downhole environments.

### BACKGROUND

In the oil and gas industry, hydrocarbons can be produced from shale, carbonate, or sandstone reservoirs. Sand production is the migration of formation sand caused by the flow of reservoir fluids (such as oil or gas or water) during production. Sand production can result from shear failure of the grain cementing material within the reservoir rock matrix. Here, “sand” can be defined in the geological sense to describe small granular materials (larger than 45 microns in diameter) of the formation (the rock matrix around a wellbore) which may be produced with the reservoir fluid.

Sand production can cause many problems during production. For example, it can either erode downhole equipment, reducing their effectiveness, or erode surface pipelines resulting in environmental concerns and safety hazards, for example, if toxic gases such as hydrogen sulfide are present in the well stream. It can also result in lost revenue due to restricted or shut-in production. Therefore, to produce hydrocarbons from the sandstone reservoirs, sand control measures must be applied to control sand production.

Sand production can be controlled by mechanical sand control methods, which provide a physical barrier to sand movement while allowing fluid to flow across passages. Either stand-alone sand screen completions or gravel-pack completions (where gravel is placed downhole between the sand and formation to restrict formation sands from movement) can be used as sand control completions. The screen aperture size as well as the gravel size must be sized appropriately to ensure that the sand grain bridges form a stable arch on the screen opening or gravel particles. This stable arch is what prevents sand grains from being produced from the formation. Therefore, the appropriate design of sand control completion is critical in formations that have a tendency towards sand production.

### SUMMARY

The present disclosure describes techniques that can be used to simulate the stability of sand grain bridges on screen openings using geomechanical characterization. Specifically, the designed geomechanical model determines a stress profile for the sand grain bridge that is forming on the screen opening and determines whether the integrity of the bridge can be affected by the resulting forces, stresses, and loads resulting from the oil production.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. For example, the designed model provides a more cost-saving method in sand control prediction compared with other traditional methods, such as laboratory testing. Further, the designed model also provides a geomechanical assessment on the stability of sand grain bridges, which is not an approach considered in existing technologies. Moreover, the designed model can be used to determine, early in a reservoir development project, the type of completion techniques that may be implemented to prevent an unforeseeable sand screen failure from occurring. In addition, the designed model can also be used to make a decision as to the point in the lifetime of a well at which to use techniques and to install equipment to mitigate sand production.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1A is a schematic of an example of a sand screen with screen slot openings.

FIG. 1B is an enlarged schematic view of the screen slot openings in the sand screen of FIG. 1A.

FIG. 2 is a schematic of an example sand grain bridge for illustrating how stable bridges are formed against screen openings, according to some implementations of the present disclosure.

FIG. 3 is a flowchart of an example process for predicting whether a stand-alone sand screen is sufficient for a wellbore using the designed model, according to some implementations of the present disclosure.

FIG. 4 is a flowchart of an example method for determining whether a stand-alone sand screen completion suffices for the sand production of a wellbore, according to some implementations of the present disclosure.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques that can be used to simulate the stability of sand grain bridges on screen openings using geomechanical characterization. Specifically, the designed geomechanical model determines a stress profile for the sand grain bridge that is forming on the screen opening and determines whether the integrity of the bridge can be affected by the resulting forces, stresses, and loads resulting from oil, water or gas production. Various modifications, alterations, and permutations of the disclosed implementations can be made and will be readily apparent to those of ordinary skill in the art. The general principles defined may be applied to other implementations and applications without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Excessive sand production may result in erosion and damage of downhole or surface equipment. Current geomechanical sand control techniques focus on determining whether the wellbore will produce excessive sand and when it will occur. However, these techniques fail to predict when one form of sand control will fail and needs to be changed. To predict whether a stand-alone sand screen completion of a given aperture size will be able to provide effective sand control (and if not when a gravel needs to be introduced between the screen and formation), this disclosure introduces a method of assessing the stability of the bridges forming against the screen openings of the sand screen completions, as will be described in more details that follow.

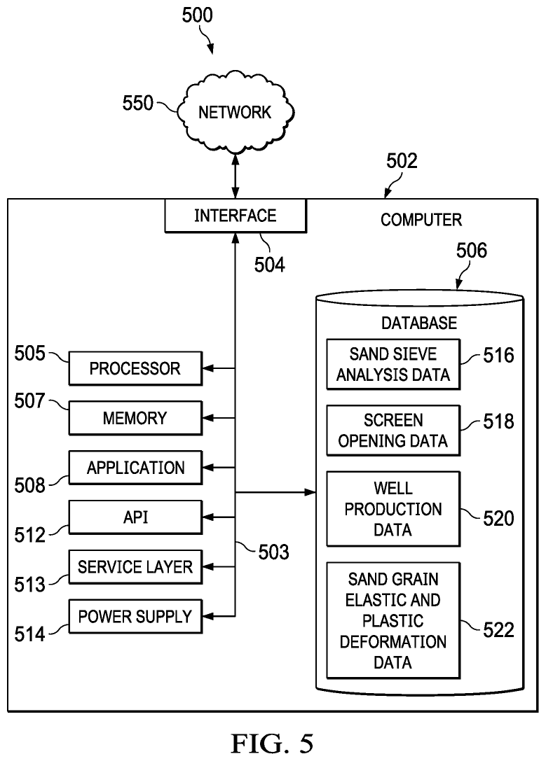

As described in this disclosure, real-time reservoir pressure data from a measurement system (for example, a Permanent Downhole Measurement System (PDHMS)) is used to calculate current and future stress loads acting on sand bridges that form on the apertures of downhole sand screens. In some implementations, the PDHMS can be implemented as a computer 502 described later with reference to FIG. 5. A point in future time is determined as to if and when the sand bridges (arches) will fail. In response, a recommended course of action is provided. The action can be one or more of the following—for an existing well, schedule the well for a workover to reenter and change the completion from a stand-alone sand screen to screen and gravel completion; for a new well currently being designed, recommend a gravel pack completion as the optimum sand control design method and recommend an appropriate gravel (proppant) strength accordingly; enabling details, for example, a trend of reservoir pressure versus time can be established for each sandstone well from data from the measurement system. This trend can be extrapolated to obtain the expected reservoir pressure at every day for the life of the well, which can be as high as 20 years. For example, over 7000 iterative calculations can be performed per well, meaning over 700,000 iterative calculations for a field with 100 wells. Calculations to determine the resulting stress load acting on the sand grain bridges are described later.

Having performed the more than 700,000 iterative calculations, a point in the calculations in which the stress load is more than what will cause the sand grains to fail is determined either using Mohr-Coulomb theory (used to define the shear strength of the grains) or rock geomechanics laboratory testing, which defines the strength of the sand particles of the field. Having identified such point in time when the sand screens will fail, a recommendation for a workover to be done on the wells prior to the predicted failure is provided. In response, operators can introduce gravel and avoid erosion of surface pipelines due to sand production for existing wells. The design process of new wells can be aided by performing similar calculations on nearby wells with similar downhole pressures, and recommending gravel pack or sand screens accordingly. If the calculation shows that the sand grain bridges will not fail as a result of depletion throughout the life of the well, then a sand screen completion would suffice and the cost of the gravel can be saved. However, if the calculations show that a standalone sand screen would not suffice, that is, the sand bridges will fail in year 10, 12, 13, for example, then a gravel pack completion can be recommended as part of the initial sand control completion design.

The techniques described in this disclosure can be implemented with sand screens of different types, for example, premium mesh sand screens or wire wrapped sand screens. Premium mesh sand screens are layers of woven mesh on top of each other that create an opening that is constructed and centered between a base pipe with circular openings and an outer protective shroud with circular openings. Wire wrapped screens have a wire constructed around a perforated base pipe without a protective shroud which results in non-circular openings. Also, the downhole pressure gauges described in this disclosure can be different features. For example, the gauges can be permanent or retrievable (that is, retrofit), quartz- or sapphire-based, have an electric line to the surface or be operated wirelessly.

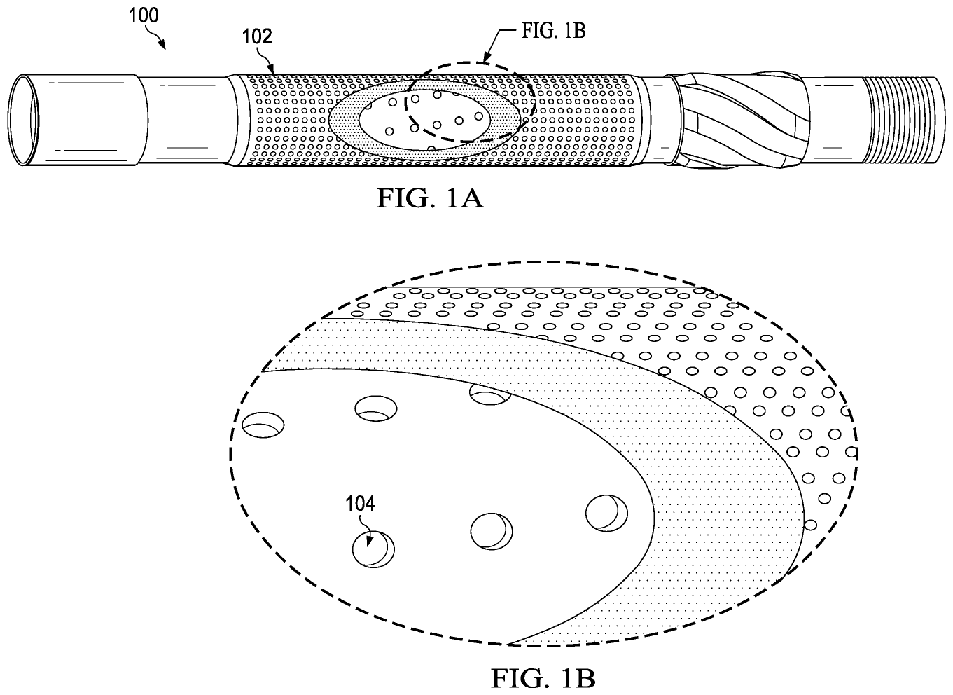

FIG. 1 is a graph of an example stand-alone sand screen completion 100 for illustrating the method of determining sand screen aperture size in sand screen design, according to some implementations of the present disclosure.

The stand-alone sand screen completion 100 is effective in controlling sand production from the formation and is composed of clean, large, grained sands with narrow grain size distribution. In the case where the formation has collapsed behind the sand screen 102, the largest sand grains tend to form a bridge to prevent other large grains from entering the screen. These large grained sands (>45 microns) should be stopped by the stable arch (bridge) 104. Therefore, the screen should be designed to effectively bridge formation sand while retaining maximum productivity. This is achieved by selecting the appropriate size (slot width), geometry, and density of screen slot openings 104 to trap the larger grains, which in turn trap smaller grains in the interstices of larger grains.

Currently, the standard practice in the industry for designing sand screen aperture sizes (that is, the “screen slot openings 104” as illustrated in FIG. 1) is to conduct laboratory retention testing. In its simplest forms (the so-called “sieve analysis,” which involves sorting sand grains of similar sizes using a series of sieves), the sand obtained from representative core samples is passed through various sieve sizes, resembling different screen aperture openings under static conditions.

Laboratory retention testing can also be more complicated. For example, the testing can be conducted in miniature flow loop tests under dynamic conditions to accurately quantify the amount of sand expected to be produced using different screen aperture sizes. Based on the results of the amount of sand produced for each screen slot opening 104 in these tests, the appropriate size for the screen slot openings 104 is then selected. This approach is usually the screen opening size that meets a specific success criterion with regards to the amount of sand being produced. This type of complex retention testing under dynamic conditions provides better representation when compared to the static sieve analysis. However, the cost of the miniature flow loop testing is expensive. The disclosure can, in some implementations, provide a more cost-effective alternative by simulating this dynamic lab testing in a computer application especially if the sand screen design process is done on a routine basis for multiple fields, where the cost increases significantly.

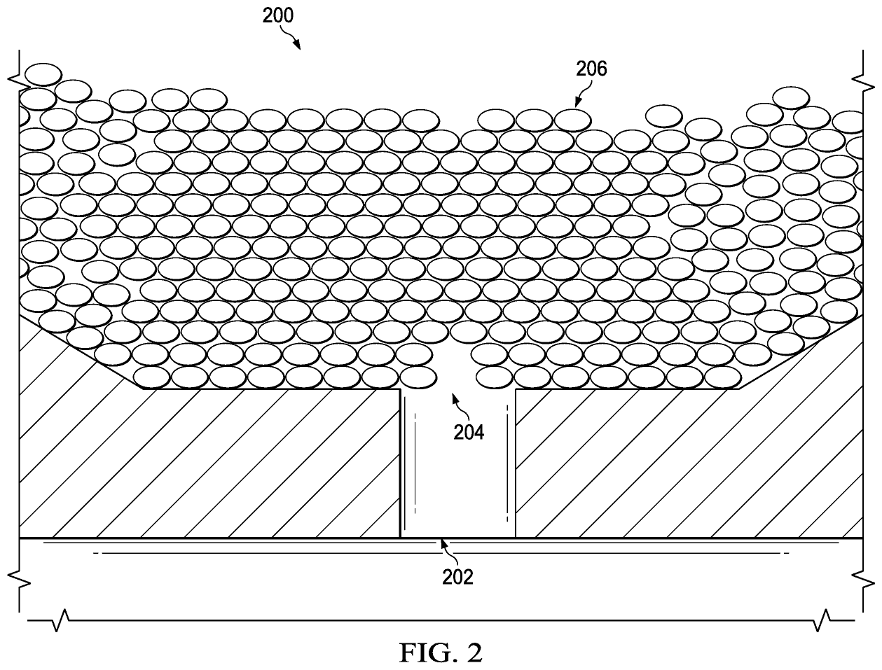

FIG. 2 is a graph of an example sand grain bridge 200 for illustrating how stable bridges are formed against screen openings, according to some implementations of the present disclosure.

Sand screens work by retaining the formation sand based on a concept called “bridging.” In this concept, the sand particles bridge against screen circular openings and non-circular openings, creating a stable bridge or “arch” on the sand screen aperture. The stable bridges or “arches” prevent remaining sand particles from being passed through the same screen openings. The creation of a stable arch is the basic function that the screen performs to retain the formation sand.

Because of the bridging concept, sand screen aperture 202 is usually designed or sized in a way that enables these bridges to form. For example, the Coberly criteria introduces a correlation based on average sorting of formation sand. In the Coberly criteria, the slot width w is determined from the correlation:

w=2d₁₀ (1)

In Equation (1), d₁₀ is the 10^{th} percentile of formation sand.

The correlation of Equation (1) is based on an understanding that the sand grains 206 may form a stable sand grain bridge 204 on sand screen aperture 202 that is twice the size of the 10^{th} percentile of formation sand. However, such a correlation has no accounting for sorting or uniformity of sand and therefore may not give reliable results.

One of the main factors that determines the stability of the sand grain bridge 204 is the geomechanical stress profile along the sand grains 206 making up that sand grain bridge 204. This profile can be characterized by developing a computer-implemented geomechanical simulation model. The geomechanical model can be used, via computers, to determine whether a stand-alone screen completion is sufficient or not by calculating whether a stable sand grain bridge 204 would form on the sand screen aperture 202. That is, this computer-based simulation model can exhibit a stress profile that may result in destabilization of the sand grain bridge 204. For example, high production rates cause a load greater than what the sand grain bridge 204 can handle (that is, elastic or plastic deformation of sand grains 206). In these instances, sand can be passed through the sand screen aperture 202 (unsuccessful sand control). As a result, a gravel will have to be placed between the screen and formation in what is known as a gravel-pack completion. The software model can produce outputs including calculated stress profiles, recommendations and associated visual aids, graphs, and reports through the simulation run.

Based on the previously mentioned features, this disclosure is directed to simulating the stability of sand grain bridges on screen openings using geomechanical characterization. Existing sand control methods lack proper geomechanical characterization of sand screen bridging stability and provide recommendations derived from laboratory experiments or sand sieve testing. The described solution considers geomechanical characterization of sand grain bridge stability on screen openings, and uses computer software to predict if and when a sand screen failure will occur, and to what extent, early on in a well development project.

Specifically, the present disclosure describes a geomechanical model that calculates the stress profile along the sand grains making up the bridges. The model then compares the calculated stress profile to plastic and elastic deformation limits/thresholds of sand grains making up the bridges throughout the entire life of the well. Based on the comparison result, assessments can be made as to whether a stand-alone sand screen completion would suffice, or otherwise when a gravel pack completion needs to be implemented. In addition, using the proposed model, a time point of when the sand screen will fail can be predicted both before the drilling even starts and for existing wells that have already been drilled and completed with sand screens. In this way, when a workover rig will be required can be determined and planned.

The geomechanical model converts production rates to stresses/loads and compares the loads to elastic and plastic deformation thresholds to assess the stability of bridges, to predict the effectiveness of a stand-alone sand screen for that scenario as opposed to a gravel-pack completion. Predictions made in this particular fashion introduces significant cost savings, as the software would be able to simulate the results of the lab testing. Operators may no longer require miniaturized flow loop retention testing in dynamic conditions to design sand screen openings. With this simulation model, the design can be done automatically using computer software. This model can avoid a number of costly laboratory experiments.

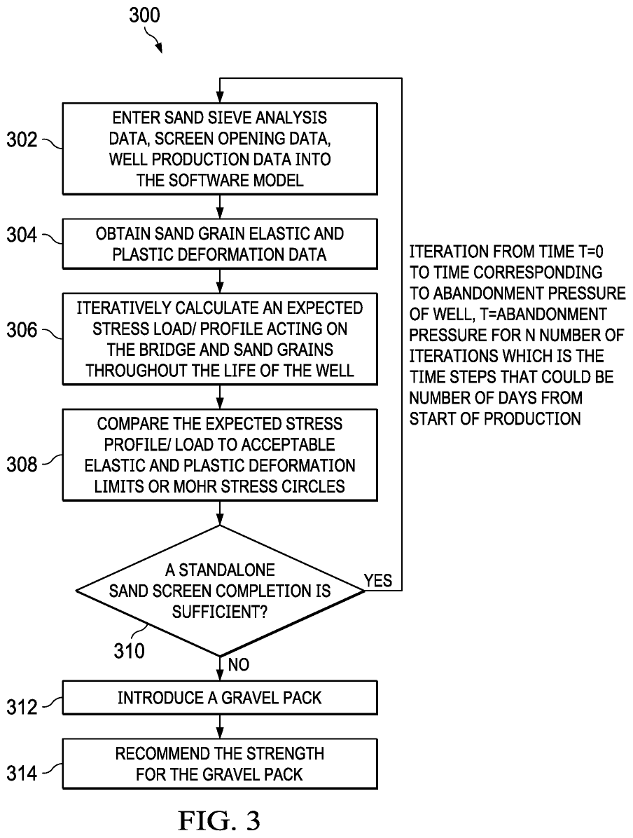

FIG. 3 is a flowchart of an example process 300 for predicting whether a stand-alone sand screen is sufficient for a wellbore using the designed model, according to some implementations of the present disclosure.

At 302, sand sieve analysis data, screen opening data, and well production data are entered into the software model.

Sand sieve analysis involves sorting of sand of similar sizes using a series of sieves. Prior to conducting the analysis, sample sands are cleaned and dried. Then the weighted sample is placed on the top sieve of series sieves that are shaken mechanically. Materials (grains) retained in each sieve are weighted and plotted in a cumulative weight versus diameter graph to present a grain size distribution.

Screen opening data includes data of slot size (slot width), slot geometry, slot pacing, orientation, and density, as well as other data associated with a sand screen design.

Well production data indicates physical or chemical properties of material within the geomechanical reservoir. Well production data includes, but is not limited to, types of formation material, porosity of formation material, permeability of formation material, types of fluid in the reservoir, pore pressure, temperature, viscosity of a fluid of a fluid in the wellbore, geomechanical forces of fluid flow in the wellbore, and the depth of the wellbore.

Data such as rock properties can be obtained by gathering and analyzing available data from testing done on the reservoir. In addition, such data can be obtained from any existing wells in the reservoir. Data related to the expected pore pressure can be provided by commercially available gauges, for example, the permanent downhole monitoring systems (PDHMS).

At 304, sand grain elastic and plastic deformation data are obtained. For example, the data can be obtained physically by conducting a crash test on the sane grains in the laboratory using a downhole core sample. In another example, the data can be obtained by mathematical calculation using Mohr-Coulomb criteria.

Sand grain elastic deformation data is associated with the elastic behavior of a given material, which is described in terms of the elastic parameters. This type of data includes, but is not limited to, Young's modulus, Poisson's ratio, yield strength, a stress-strain curve for the material, an ultimate strength, strain hardening behavior, and point of fracture.

Sand grain plastic deformation data indicates onset of plastic deformation, that is, the point of transition from elastic to plastic behavior. For example, yield strength can be used to pinpoint an elastic limit of a material. Additional stress on the material beyond the yield strength can cause permanent (plastic) deformation to occur.

Sand grain elastic and plastic deformation data can be obtained from tests performed on one or more samples taken from a site of an actual well or a proposed well.

At 306, an expected stress load/profile acting on the bridge and sand grains throughout the life of the well is iteratively calculated.

Increase in effective stress could affect productivity, wellbore stability, and safety, as well as stability of the oil platforms. Effective stress in the surface can be defined ideally as the difference between the overburden stress (σₒᵥ) and a fracture of the pore pressure (Pₚ), according to Equation (2):

σ′=σₒᵥ−nPₚ (2).

The fraction n is known as the effective stress coefficient or Biot's coefficient. Typically, n is calculated from the bulk compressibility, determined under hydrostatic stress condition. Due to elastic deformation in the grains, surface contact between the grains will increase or reduce if the pore pressure or overburden stress changes. Consequently, the effective stress coefficient will also change.

At 308, the calculated stress/loads from production forces acting on the bridge is compared to acceptable elastic and plastic deformation limits or Mohr Stress Circles. In some implementations, elastic deformation limits is chosen as a defining parameter over plastic deformation limits due to the tendency of even elastic deformation to destabilize the sand bridge.

In some implementations, the software model can determine a yield point that indicates the limit of elastic behavior and the beginning of plastic behavior. The elastic limit (yield strength) is the least stress point at which permanent deformation can be measured. In the industry, a 20% safety factor is introduced. The calculated stress/loads is compared to 80% of acceptable elastic and plastic deformation limits.

In some implementations, the software model can determine what the stresses within the reservoir are going to do when the pore pressure changes by applying a yield criterion. For example, this stress state information can be inputted into a Mohr-Coulomb failure envelope to evaluate whether the identified stresses on the rock will have a tendency to fail and, if so, when the failure may occur. The Mohr-Coulomb failure envelope delineates stable and unstable states of stress for given rock material.

At 310, a determination is made on whether a stand-alone sand screen completion will suffice to retain the downhole sand or if gravel needs to be introduced.

At 312, if it is determined that the stand-alone sand screen completion is not sufficient, a recommendation is made to introduce a gravel pack.

In some implementations, based on the comparison results, a point in time with regards to when it needs to be introduced and the well needs to be sidetracked if it is an existing (drilled well) can also be predicted.

In some implementations, visual aids, graphs, and reports are also produced with the generated stress profiles and recommendations to a better presentation.

At 314, if it is determined that gravel is needed, a recommendation is made on the required gravel/proppant strength. For example, a notification can be transmitted that the well will require a workover to allow timely planning of the workover to avoid any shut down.

Typically, the gravel strength needs to at least equal the calculated effective stress to sustain the expected sand production.

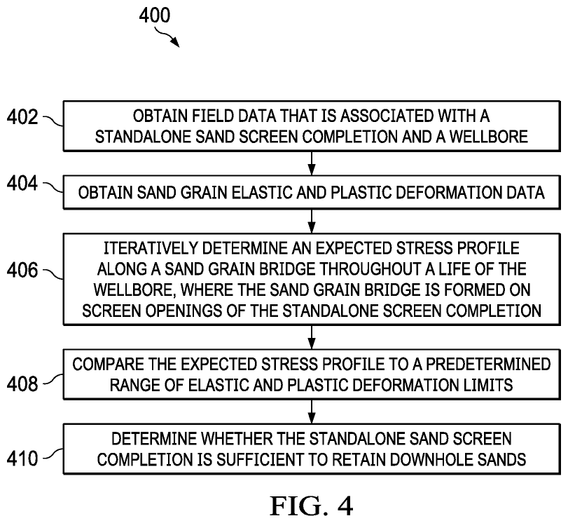

FIG. 4 is a flowchart of an example method 400 for determining whether a stand-alone sand screen completion suffices for the sand production of a wellbore, according to some implementations of the present disclosure. For clarity of presentation, the description that follows generally describes method 400 in the context of the other figures in this description. However, it will be understood that method 400 can be performed, for example, by any suitable system, environment, software, and hardware, or a combination of systems, environments, software, and hardware, as appropriate. In some implementations, various steps of method 400 can be run in parallel, in combination, in loops, or in any order.

At 402, field data that is associated with a stand-alone sand screen completion and a wellbore are obtained. In some implementations, the field data comprises sand sieve analysis data, screen opening data, and well production data.

At 404, sand grain elastic and plastic deformation data are obtained.

At 406, an expected stress profile along a sand grain bridge is iteratively determined throughout a life of the wellbore, where the sand grain bridge is formed on screen openings of the stand-alone screen completion. In some implementations, the expected stress profile results from production forces acting on the sand grain bridge.

At 408, the expected stress profile is compared to a predetermined range of elastic and plastic deformation limits. In some implementations, the expected stress profile is compared to a Mohr-Coulomb yield criterion.

At 410, whether the stand-alone sand screen completion is sufficient to retain downhole sands is determined.

In some implementations, in response to a determination that the stand-alone sand screen completion is not sufficient, a recommendation of introducing a gravel-pack is made. In such implementations, a recommendation of the strength of the gravel-pack is also made.

In some implementations, where the wellbore is a drilled well, in response to a determination that the stand-alone sand screen completion is not sufficient, a point in time to reenter the wellbore is predicted.

FIG. 5 is a block diagram of an example computer system 500 used to provide computational functionalities associated with described algorithms, methods, functions, processes, flows, and procedures described in the present disclosure. The illustrated computer 502 is intended to encompass any computing device such as a server, a desktop computer, a laptop/notebook computer, a wireless data port, a smartphone, a personal data assistant (PDA), a tablet computing device, or one or more processors within these devices, including physical instances, virtual instances, or both. The computer 502 can include input devices such as keypads, keyboards, and touch screens that can accept user information. In addition, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 550. In some implementations, one or more components of the computer 502 can be configured to operate within different environments, including cloud-computing-based environments, local environments, global environments, and combinations of environments.

The computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 503 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 505. In some implementations, any or all of the components of the computer 502, including hardware or software components, can interface with each other or the interface 504 (or a combination of both), over the system bus 503. Interfaces can use an application programming interface (API) 512, a service layer 513, or a combination of the API 512 and service layer 515. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 550 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502. Some examples of data stored in the database 506 are, sand sieve analysis data 516, screen opening data 518, well production data 520, and sand grain elastic and plastic deformation data 522.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 550. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, a computer-implemented method, field data that is associated with a stand-alone sand screen completion and a wellbore is obtained. Sand grain elastic and plastic deformation data is obtained. An expected stress profile along a sand grain bridge is iteratively determined throughout a life of the wellbore. The sand grain bridge is formed on screen openings of the stand-alone screen completion. The expected stress profile is compared to a predetermined range of elastic and plastic deformation limits. It is determined whether the stand-alone screen completion is sufficient to retain downhole sands.

The foregoing and other described implementations can each, optionally, include one or more of the following features.

In a first feature, combinable with any of the following features, the field data includes sand sieve analysis data, screen opening data and well production data.

In a second feature, combinable with any of the previous or following features, the expected stress profile is resulted from production forces acting on the sand grain bridge.

In a third feature, combinable with any of the previous or following features, the expected stress profile is compared to a Mohr-Coulomb yield criterion.

A fourth feature, combinable with any of the previous or following features, includes recommending to introduce a gravel-pack in response to a determination that the stand-alone sand screen completion is not sufficient.

A fifth feature, combinable with any of the previous or following features, includes making a recommendation on a strength of the gravel-pack.

In a sixth feature, combinable with any of the previous or following features, the wellbore is a drilled well. In response to a determination that the stand-alone sand screen completion is not sufficient, a point in time to reenter the wellbore is predicted.

A seventh feature, combinable with any of the previous or following features includes transmitting a notification in response to the determination that the stand-slone sand screen completion is not sufficient.

For example, in another implementation, the foregoing or previous features, taken alone or in any combination can be implemented as a computer-readable medium (for example, non-transitory or transitory computer-readable medium) storing instructions executable by one or more processors to perform the operations described in this disclosure. In another implementation, the foregoing or previous features, taken alone or in any combination can be implemented as a system that includes one or more processors and a computer-readable medium storing instructions executable by the one or more processors to perform the operations described here.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
obtaining field data that is associated with a stand-alone sand screen completion and a wellbore;
obtaining sand grain elastic and plastic deformation data;
iteratively determining an expected stress profile along a sand grain bridge throughout a life of the wellbore, wherein the sand grain bridge is formed on screen openings of the stand-alone screen completion;
comparing the expected stress profile to a predetermined range of elastic and plastic deformation limits; and
determining whether the stand-alone sand screen completion is sufficient to retain downhole sands.

2. The computer-implemented method of claim 1, wherein the field data comprises sand sieve analysis data, screen opening data, and well production data.

3. The computer-implemented method of claim 1, wherein the expected stress profile is resulted from production forces acting on the sand grain bridge.

4. The computer-implemented method of claim 1, wherein the expected stress profile is compared to a Mohr-Coulomb yield criterion.

5. The computer-implemented method of claim 1, further comprising:
in response to a determination that the stand-alone sand screen completion is not sufficient, recommending to introduce a gravel-pack.

6. The computer-implemented method of claim 5, further comprising making a recommendation on a strength of the gravel-pack.

7. The computer-implemented method of claim 1, wherein the wellbore is a drilled well, and further comprising in response to a determination that the stand-alone sand screen completion is not sufficient, predicting a point in time to reenter the wellbore.

8. The computer-implemented method of claim 7, further comprising transmitting a notification in response to the determination that the stand-alone sand screen completion is not sufficient.

9. A non-transitory computer-readable medium storing instructions executable by one or more processors to perform operations comprising:
obtaining field data that is associated with a stand-alone sand screen completion and a wellbore;
obtaining sand grain elastic and plastic deformation data;
iteratively determining an expected stress profile along a sand grain bridge throughout a life of the wellbore, wherein the sand grain bridge is formed on screen openings of the stand-alone screen completion;
comparing the expected stress profile to a predetermined range of elastic and plastic deformation limits; and
determining whether the stand-alone sand screen completion is sufficient to retain downhole sands.

10. The medium of claim 9, wherein the field data comprises sand sieve analysis data, screen opening data, and well production data.

11. The medium of claim 9, wherein the expected stress profile is resulted from production forces acting on the sand grain bridge.

12. The medium of claim 9, wherein the expected stress profile is compared to a Mohr-Coulomb yield criterion.

13. The medium of claim 9, further comprising, in response to a determination that the stand-alone sand screen completion is not sufficient, recommending to introduce a gravel-pack.

14. The medium of claim 13, further comprising making a recommendation on a strength of the gravel-pack.

15. The medium of claim 9, wherein the wellbore is a drilled well, and further comprising in response to a determination that the stand-alone sand screen completion is not sufficient, predicting a point in time to reenter the wellbore.

16. The medium of claim 15, further comprising transmitting a notification in response to the determination that the stand-alone sand screen completion is not sufficient.

17. A system comprising:
one or more processors; and
a computer-readable medium storing instructions executable by the one or more processors to perform operations comprising:
obtaining field data that is associated with a stand-alone sand screen completion and a wellbore;
obtaining sand grain elastic and plastic deformation data;
iteratively determining an expected stress profile along a sand grain bridge throughout a life of the wellbore, wherein the sand grain bridge is formed on screen openings of the stand-alone screen completion;
comparing the expected stress profile to a predetermined range of elastic and plastic deformation limits; and
determining whether the stand-alone sand screen completion is sufficient to retain downhole sands.

18. The system of claim 17, wherein the field data comprises sand sieve analysis data, screen opening data, and well production data.

19. The system of claim 17, wherein the expected stress profile is resulted from production forces acting on the sand grain bridge, wherein the expected stress profile is compared to a Mohr-Coulomb yield criterion.

20. The system of claim 17, wherein the operations further comprise:
in response to a determination that the stand-alone sand screen completion is not sufficient:
recommending to introduce a gravel-pack or making a recommendation on a strength of the gravel-pack,
predicting a point in time to reenter the wellbore, and
transmitting a notification.
